(19) United States
(12) Patent Application Publication
(10) Pub. No.: US 2004/0146612 A1
(43) Pub. Date: Jul. 29, 2004

(54) Method for treating foods and beverages to hide odor of trans-2-nonenal and foods and beverages so treated

(76) Inventor: Joseph L. Owades, Sonoma, CA (US)

Correspondence Address: Attention: Norman P. Soloway, HAYES SOLOWAY P.C., 130 W. Cushing Street, Tucson, AZ, 85701, US

(21) Appl. No.: 10/337,705

(22) Filed: Jan. 7, 2003

(51) Int. Cl. A23B 4/00

(52) U.S. Cl. 426/124

(57) ABSTRACT

Foods and beverage products are treated to hide the odor of trans-2-nonenal which normally occurs on storage, by treating the foods or beverages, prior to storage, by contacting with toasted granulated oak wood particles.

### FIELD OF THE INVENTION

Trans-2-nonenal is a ubiquitous compound found in many foods, particularly those with high levels of unsaturated fatty acids. It is also found in foods like coffee, cucumbers, watermelon, beer, potatoes, carrots and also in foods subjected to “freezer burn”. This is a common phenomena in foods containing unsaturated fatty acids that have been cooked and frozen.

### BACKGROUND OF THE INVENTION

The precursor of trans-2-nonenal is linoleic acid, the most common unsaturated fatty acid in most foods. Linoleic acid is prone to breakdown both enzymatically and thermally.

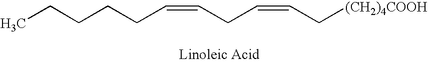

The enzyme lipogenase breaks linoleic acid down to trans-2-nonenal, as does thermal degradation.

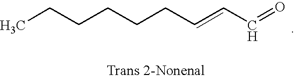

In some foods, the unsaturated aldehyde is not objectionable, perhaps because foods like cucumbers, themselves hide the aldehyde.

But in others, the odor of trans-2-nonenal is considered unpleasant. This is particularly so in the case in freezer burned frozen food and in the case in old or stale beer. In both, the odor of trans-2-nonenal has become an identifying mark of oxidation.

Flavor is a key attribute of frozen foods because they had been frozen to keep their flavor the way it was in fresh food. Flavor is also a key attribute of beer, and its staling during storage after packaging has long been a concern to brewers. Several types of reactions have been thought to be responsible for the development of the aged characters during the storage of frozen foods and of beer. But it is now accepted that stale flavors primarily are caused by various unsaturated carbonyl compounds, especially those with very low thresholds and having 7 to 10 carbon atoms. Trans-2-nonenal has received particular attention in view of the unwelcome flavor note appearing in both frozen foods and aged beer.

The cooking of starchy, proteinaceous and fatty foods and the operation of a brewhouse have much in common. Cooking consists of raising the temperature of the ambient food to a predetermined elevated temperature and holding it at that temperature for a predetermined time. During these time intervals, many of the food enzymes have the opportunity to operate. Included in these are lipoxygenase. And, at higher temperature, the thermal degradation of linoleic acids plays a significant role in the formation of trans-2-nonenal.

The brewing of beer produces temperatures from 100° F. to 212° F., and similarly provides opportunities for the action of lipogenase and the thermal degradation of linoleic acid.

### OBJECT OF THE INVENTION

It is therefore an object of the present invention to treat foods and beverages to hide or mediate the odor caused by freezer burn and staling.

### BRIEF DESCRIPTION OF THE INVENTION

I have found that contacting frozen food before freezing with toasted particles of oak wood serves as a protective mask to hide the odor of trans-2-nonenal. Similarly, contacting beer during lagering with the toasted particles of oak wood serves to protect the beer from the odor of trans-2-nonenal during subsequent packaged storage.

### DETAILED DESCRIPTION OF THE INVENTION

Trans-2-nonenal is produced by the normal and inevitable working of time and temperature. Consumption of cooked ground beef has increased because of ease of preparation, versatility, and good value. However, this product is susceptible to “freezer burn” or oxidative rancidity. Freezer burn also develops in cooked meats during periods of refrigerated storage. The most likely cause of freezer burn development is oxidation of membrane phospholipids.

As lipids oxidize, a mixture of aldehydes and ketones is produced. These classes of compounds are responsible for development of undesirable flavor or odor attributes, such as cardboard. As their concentrations increase, and desirable flavors decrease during storage, freezer burn appears to result from this combined chemical process in which lipid oxidation products are increased and desirable meaty flavor compounds are diminished.

Use of antioxidants as a means of preventing or decreasing oxidative rancidity has been studied. The bisulfite ion has long been the simplest way to hide, mask or mediate aldehydes. The sulfite adduct forms with many aldehydes.

But the bisulfite ion adducts are inherently unstable, and easily break down to unsaturated aldehydes and bisulfites.

Synthetic antioxidants, such as butylated hydroxyanisole and butylated hydroxytoluene also have been studied in meat products. They have not been very effective in preventing freezer burn.

I have found that contacting frozen food before freezing with toasted particles of oak wood serves as a protective mask to hide or mediate trans-2-nonenal. Similarly, contacting beer during lagering by the toasted particles of oak wood serves to protect the beer from the odor of trans-2-nonenal during storage.

For freezer burn, this invention provides for a mask for aldehydes produced by oxidative rancidity. For beer this invention provides for the masking of aldehydes produced between the packaging date and the time when the beer breaks down from normal senescence. This occurs normally by protein-tannin interactions.

More particularly, I have found that the exposure of food or beverage products to dried, toasted oak wood (Quercus alba and/or Quercus robus), in particulate form, i.e. shavings, chips, powder or other small entities, or an extract thereof, provides flavor stability to the food or beverage products for periods up to one year or longer.

The toasted oak wood particles my be added directly to the food product before cooking or freezing. In the case of beer, the exposure to the oak wood particles may be done after the main fermentation, during the aging process, but also may be done before or after the standard aging stage. The aging process may be conducted in any of the three standard aging methods—simple lagering (allowing fermented beer to be stored for several days or weeks in a tank); second fermentation (removing the settled yeast from a fermenting tank before the fermentation has been completed and allowing fermentation to slowly proceed to or near the limit of fermentation); or krauesening (treating of freshly fermented beer with a small portion, about 15% by volume, of beer that just started fermenting a day before). The addition of the oak wood particles preferably is done at the inception of the aging process.

When using oak wood particles in accordance with the present invention, the wood particles should be as the wood comes from the tree, i.e. the oak wood particles should be unwashed; however, the oak wood particles must be dried and toasted in air, under controlled conditions, i.e. at a temperature between about 300° F. and about 400° F., to a moisture content of about 0.5% to 1% by weight, preferably about 1% by weight, prior to use. In order to ensure low moisture content prior to use, the oak wood particles preferably are stored in an airtight container after toasting. Also, the dried oak wood particles, which have low density and poor wetting characteristics, tend to float on the foam on top of the beverage as the tank is being filled. Accordingly, in the case of a beverage, in order to ensure intimate and lasting contact between the oak wood particles and the beverage, the oak wood particles should be loosely packaged in a porous or permeable fabric bag or container which is weighed down with a dense material such as glass, stainless steel or other dense material which is inert to the beverage, such that the wood-particle containing bag or container sinks in the tank or remains suspended in the beverage, but does not float to the top. Alternatively, the wood particle-containing bag or container may be tied to a cleat on the side or bottom of the tank, or to a cooling coil or the like in the tank, or the container may be tied to an anchor.

Alternatively, the toasted oak wood particles may be extracted by acidified water, and the extract added to the food or beverage. The flavor stabilizing improvement appears to be dependent upon the quantity of oak wood particles added. Thus, in the case of a beverage, the oak wood particles should be added in an amount of about 0.05 lbs. per 100 lbs. of malt beverage (or 0.13 lbs. per bbl. of malt beverage). Addition of less than about 0.01 lbs. per 100 lbs. of malt beverage (or 0.03 lbs. per bbl. of malt beverage) appears to result in little improvement in flavor stability. On the other hand, addition of more than about 0.8 lbs. per 100 lbs. of malt beverage (or 2.0 lbs. per bbl. of malt beverage) appears to result in little additional improvement in flavor stability.

If added directly to the beverage, the oak wood particles should be filtered before the beverage is packaged. Alternatively, a small porous pouch containing toasted oak wood particles may be affixed, for example, to the bottom of the beverage container.

In yet another embodiment, the toasted oak wood is extracted, and the extract added directly to the beverage. In such case, the extract may be added at any time after the main fermentation, during aging, and/or just prior to packaging.

When added to a food product, the oak wood particles should be reduced to a size not greater than about 35 to 100 U.S. sieve so as to not change the texture of the food product. Of course, if an extract of the toasted oak wood is used, texture is not an issue.

Toasted, dried oak wood (Quercus alba and/or Quercus robus) appears to be unique in stabilizing food or beverage products against oxidation. Other wood particles have been tested and are found not to provide a similar effect.

The flavor stabilizing improvement appears to be independent of the size and form of the oak wood particles; however, for a given weight, smaller particles appear to be preferred. It is believed that this is because the smaller particles have a relatively larger surface area which facilitates extraction of the materials which impart the oxidation stabilizing effect in accordance with the present invention.

The resulting food or beverage products have superior flavor stability over similar food and beverage products made without the addition of toasted oak wood particles, and none of the disadvantages of undesirable aromas resulting from freezer burn of frozen foods and staling of beverages.

The present invention will be further described in the following working examples.

### Preparation A of Dried Oak Wood Particles

White oak wood chips (Quercus alba) were prepared by planing white oak stock. The chips were placed in an oven and heated to 300-400° F. for about 30-90 minutes, until they were browned slightly, and the moisture content measured about 1% by weight.

### Preparation B of Dried Oak Wood Particles

Preparation A was repeated, however employing red oak particles (Quercus robus) and glass beads as ballast.

### Preparation C—Oak Wood Extract

An extract of 300 g. of granulated oak particles, as in Preparation A, were mixed with 3,000 ml of a 1% solution of citric acid and let stand for 48 hours. After that time, the mixture was filtered and the extract used.

### EXAMPLE I

One pound of beef (25% fat) was ground with 3.0 g. of toasted granulated (white) oak wood. Another pound was ground without oak.

These mixtures were packed in aluminum foil and frozen at −2° C.

After two (2) weeks of storage in a freezer with daily thawing, the ground beef was tested by a panel trained to detect and rate food odors. The ground beef without any oak showed signs of the presence of trans-2-nonenal or freezer burn, but the beef with the oak showed no odors of freezer burn.

### EXAMPLE II

Example I was repeated, except that 5.0 grams of toasted oak wood extract obtained from Preparation C was added in place of granulated oak wood. The mixtures were packed in aluminum foil and frozen as before, and tested after two weeks of storage in a freezer with daily thawing, and the ground beef was tested by a trained panel. As before, the ground beef without any oak showed signs of freezer burn, but the ground beef mixed with the oak wood extract showed no odors of freezer burn.

### EXAMPLE III

Two thousand (2,000) lbs. of ground barley malt is added to 20 barrels of water in a mash tub and heated to 110° F. for 20 minutes. Then the temperature is raised to 140° F. and held there for 30 minutes. Then the temperature is raised to 158° F. and filtered in a lauter tub into a kettle.

Then the kettle is treated with 50 lbs. of hops and heated to 212° F. for 60 minutes. Then the liquid is transferred to a whirlpool tank and the wort is decanted to a cooler, when it is cooled to 58° F. and treated with air and yeast.

After the fermentation is complete, the beer is transferred to a lager tank and contacted with ¼ lbs. per barrel of toasted oak particles for two (2) weeks.

The beer is filtered and treated with chillproofing (1 lb. of papain per 100 bbl.) and bottled.

The beer was kept at ambient temperature for 9 months, after which time the beer turned cloudy and became unappetizing to drink. The beer was tested by a panel trained to detect and rate beer flavors. The taste of the beer was judged to be slightly caramelized but surprisingly did not have a cardboard or oxidized taste.

### EXAMPLE IV

One hundred (100) lbs. of barley malt and 1,000 lbs. of corn grits is heated with bbls. of hot water and raised to 212° F. for 30 minutes. This is transferred to the mash tub.

Concurrently, 2,000 lbs. of barley malt is added to 20 bbls. of water, and heated to about 130° F., with stirring, in a mash tub. The resulting malt mash is held at 130° F. and the contents of the cereal cooker were then rapidly pumped over and into the mash tub, and stirred. The combined mash, which now has a temperature of about 155° F. is held at that temperature for about 30 minutes and the temperature is raised to 167° F. The mash is filtered or strained, sparged with hot water, and boiled with 40 lbs. of hops.

The wort is spun in a whirlpool tank, and then cooled, aerated and subjected to yeast. After fermenting, the beer is exposed to toasted granules of white oak (Quercus alba) or red oak (Quercus rubra). After exposure for 12 days in a rub tank, the beer is filtered and packaged. The beer is room temperature (70-80° F.) for one year. After about 11 months, the beer turned cloudy and minute particles were seen suspended. The beer was tasted by a panel trained to detect and note beer flavors. The odor of trans-2-nonenal was not present, but a honey-like odor was apparent.

Certain changes may be made without departing from the scope of the invention herein involved. It is therefore intended that all matter contained in the above description shall be interpreted as illustrative and not in a limiting sense.

1. A method of treating a food or beverage to hide or mediate the odor of trans-2-nonenal which comprises contacting the food or beverage with toasted granulated oak wood particles or an extract thereof.

2. A method according to claim 1, wherein said toasted granulated oak wood particles are toasted, in air, at a temperature in the range of about 300° F. to about 400° F., prior to use.

3. A method according to claim 1, wherein said toasted granulated oak wood particles comprise toasted white or red oak chips.

4. A method according to claim 1, wherein said toasted granulated oak wood particles have a moisture content, prior to contacting with the malt beverage, of 1%, by weight.

5. A method according to claim 1, wherein said food is frozen following said contacting.

6. A method according to claim 1, wherein said beverage comprises a malt beverage, and is contacted with said toasted oak wood particles during krauesening or aging.

7. A method according to claim 6, wherein said toasted granulated oak wood particles are added to said malt beverage in an amount of about 0.05 lbs. per 100 lbs. of malt beverage (or 0.13 lbs. per bbl. of malt beverage) to about 0.8 lbs. per 100 lbs. of malt beverage (or 2.0 lbs. per bbl. of malt beverage).

8. A packaged food or beverage product containing linoleic acid susceptible to formation of trans-2-nonenal on storage, containing toasted granulated oak wood particles or an extract thereof to hide or mediate the odor of trans-2-nonenal.

9. A packaged food or beverage product according to claim 8, wherein said toasted granulated oak wood particles comprise toasted white or red oak wood chips.

10. A packaged food or beverage product according to claim 8, wherein said food comprises a frozen food.

11. A packaged food or beverage product according to claim 8, wherein said beverage product comprises a malt beverage.

12. A packaged food or beverage product according to claim 8, wherein said extract comprises an aqueous acid extract.

13. A packaged food or beverage product according to claim 8, wherein said toasted granulated oak wood particles have a particle size not greater than 35 to 100 U.S. sieve.
